(19) United States
(12) Patent Application Publication
(10) Pub. No.: US 2016/0131905 A1
(43) Pub. Date: May 12, 2016

(54) ELECTRONIC APPARATUS, METHOD AND STORAGE MEDIUM

(71) Applicant: Kabushiki Kaisha Toshiba, Tokyo (JP)

(72) Inventors: Yukie Takahashi, Kunitachi Tokyo (JP); Go Ito, Tokyo (JP); Kosuke Haruki, Tachikawa Tokyo (JP); Kei Imada, Hamura Tokyo (JP); Masahiro Baba, Yokohama Kanagawa (JP); Yoshiyuki Kokojima, Yokohama Kanagawa (JP); Akihisa Moriya, Kawasaki Kanagawa (JP)

(21) Appl. No.: 14/686,072

(22) Filed: Apr. 14, 2015

Related U.S. Application Data
(60) Provisional application No. 62/077,113, filed on Nov. 7, 2014.

(51) Int. Cl. G02B 27/01

(52) U.S. Cl. CPC G02B 27/017; G02B 2027/0178; G02B 2027/0138

(57) ABSTRACT

According to one embodiment, an electronic apparatus in which user can see through at least a transparent part of a first display area when the electronic apparatus is worn on a body of the user is provided. The electronic apparatus includes a camera configured to take an image of surroundings comprising a region which the user cannot see through at least a transparent part of the first display area when the electronic apparatus is worn on a body of the user, and circuitry configured to perform controlling display of the first display area by using the image of surroundings.

### CROSS-REFERENCE TO RELATED APPLICATIONS

This application claims the benefit of U.S. Provisional Application No. 62/077,113, filed Nov. 7, 2014, the entire contents of which are incorporated herein by reference.

### FIELD

Embodiments described herein relate generally to an electronic apparatus, a method and a storage medium.

### BACKGROUND

Recently, electronic apparatuses called wearable devices, which can be worn on users to be used, have been developed.

Various forms of wearable device are possible, for example, a glasses-type wearable device which is worn on the head of the user is known. For example, the glasses-type wearable device allows various types of information to be displayed on a display provided in a lens portion of the device.

However, if, for example, the glasses-type wearable device is used when the user is walking, the use is sometimes dangerous depending on the state or condition of the user.

Thus, display of the glasses-type wearable device is preferably controlled in accordance with the state or condition of the user wearing the glasses-type wearable device.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an example of an outer appearance of an electronic apparatus according to a first embodiment.

FIG. 2 shows an example of a system configuration of the electronic apparatus.

FIG. 3 is a block diagram showing an example of a functional configuration of the electronic apparatus.

FIG. 4 is a flowchart showing an example of processing procedures of the electronic apparatus.

FIG. 5 shows a case where information is displayed in a whole area of a display.

FIG. 6 shows a first display area pattern.

FIG. 7 shows a second display area pattern.

FIG. 8 shows a third display area pattern.

FIG. 9 shows a fourth display area pattern.

FIG. 10 shows a fifth display area pattern.

FIG. 11 is a figure for describing a first operation.

FIG. 12 is a figure for describing a second operation.

FIG. 13 is a figure for describing a third operation.

FIG. 14 is a figure for describing a fourth operation.

FIG. 15 is a figure for describing a fifth operation.

FIG. 16 is a figure for describing a sixth operation.

FIG. 17 is a figure for describing a seventh operation.

FIG. 18 is a figure for describing an eighth operation.

FIG. 19 is a figure for describing a ninth operation.

FIG. 20 is a flowchart showing an example of processing procedures of the electronic apparatus when an automatic display control function is turned off.

FIG. 21 is a block diagram showing an example of a functional configuration of an electronic apparatus according to a second embodiment.

FIG. 22 is a flowchart showing an example of processing procedures of the electronic apparatus.

FIG. 23 shows an example of a system configuration of an electronic apparatus according to a third embodiment.

FIG. 24 is a block diagram showing an example of a functional configuration of the electronic apparatus.

FIG. 25 is a flowchart showing an example of processing procedures of the electronic apparatus.

FIG. 26 shows an example of a system configuration of an electronic apparatus according to a fourth embodiment.

FIG. 27 is a block diagram showing an example of a functional configuration of the electronic apparatus.

FIG. 28 is a flowchart showing processing procedures of the electronic apparatus.

### DETAILED DESCRIPTION

Various embodiments will be described hereinafter with reference to the accompanying drawings.

In general, according to one embodiment, an electronic apparatus in which user can see through at least a transparent part of a first display area when the electronic apparatus is worn on a body of the user is provided. The electronic apparatus includes a camera configured to take an image of surroundings comprising a region which the user cannot see through at least a transparent part of the first display area when the electronic apparatus is worn on a body of the user, and circuitry configured to perform controlling display of the first display area by using the image of surroundings.

### First Embodiment

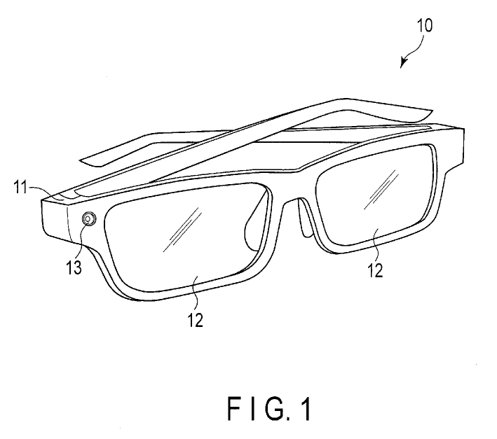

First, a first embodiment will be described. FIG. 1 is a perspective view showing an example of an outer appearance of an electronic apparatus according to the first embodiment. The electronic apparatus is a wearable device worn on, for example, the head of the user to be used (head-worn display). FIG. 1 shows an example in which the electronic apparatus is realized as a wearable device including a glasses shape (hereinafter referred to as a glasses-type wearable device). In the following description, the electronic apparatus according to this embodiment is realized as the glasses-type wearable device.

An electronic apparatus 10 shown in FIG. 1 includes an electronic apparatus body 11, a display 12 and a camera 13.

The electronic apparatus body 11 is embedded, for example, in a frame portion of a glasses shape of the electronic apparatus 10 (hereinafter referred to as a frame portion of the electronic apparatus 10). It should be noted that the electronic apparatus body 11 may be attached to, for example, a side of the frame portion of the electronic apparatus 10.

The display 12 is supported by a lens portion of the glasses shape of the electronic apparatus 10 (hereinafter referred to as a lens portion of the electronic apparatus 10). Then, if the electronic apparatus 10 is worn on the head of the user, the display 12 is arranged in a position visually identified by the user.

The camera 13 is mounted on a frame of the electronic apparatus 10 near the display 12 as shown in, for example, FIG. 1.

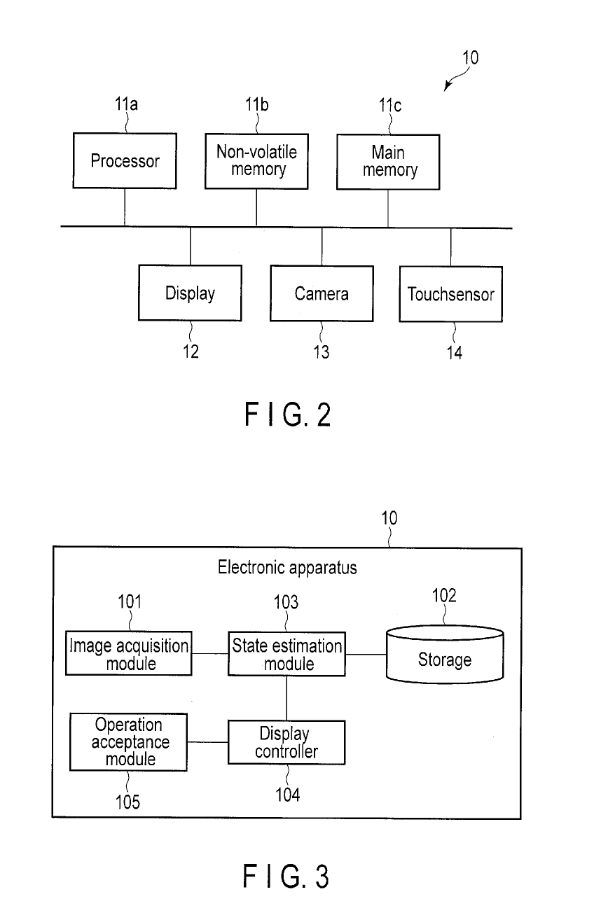

FIG. 2 shows a system configuration of the electronic apparatus 10 according to this embodiment. As shown in FIG. 2, the electronic apparatus 10 includes, for example, a processor 11a, a non-volatile memory 11b, a main memory 11c, the display 12, the camera 13 and a touchsensor 14. In this embodiment, the processor 11a, the non-volatile memory 11b and the main memory 11c are provided in the electronic apparatus body 11 shown in FIG. 1.

The processor 11a is a processor configured to control an operation of each component in the electronic apparatus 10. The processor 11a executes various types of software loaded from the non-volatile memory 11b which is a storage device into the main memory 11c. The processor 11a includes at least one processing circuitry, for example, a CPU or an MPU.

The display 12 is a display for displaying various types of information. The information displayed on the display 12 may be kept in, for example, the electronic apparatus 10, or may be acquired from an external device of the electronic apparatus 10. If the information displayed on the display 12 is acquired from the external device, wireless or wire communication is executed between the electronic apparatus 10 and the external device through, for example, a communication device (not shown).

The camera 13 is an imaging device configured to image surroundings (take an image of surroundings) of the electronic apparatus 10. If the camera 13 is mounted in a position shown in FIG. 1, the camera 13 can image a scene in a sight direction of the user (that is, a scene in front of user's eyes). It should be noted that the camera 13 can take, for example, a still image and a moving image.

The touchsensor 14 is a sensor configured to detect a contact position of, for example, a finger of the user. The touchsensor 14 is provided in, for example, the frame portion of the electronic apparatus 10. For example, a touchpanel can be used as the touchsensor 14.

FIG. 3 is a block diagram mainly showing a functional configuration of the electronic apparatus 10 according to this embodiment. As shown in FIG. 3, the electronic apparatus 10 includes an image acquisition module 101, a storage 102, a state estimation module 103, a display controller 104 and an operation acceptance module 105.

In this embodiment, all or part of the image acquisition module 101, the state estimation module 103, the display controller 104 and the operation acceptance module 105 may cause the processor 11a to execute a program, that is, may be realized by software, may be realized by hardware such as an integrated circuit (IC) or may be realized as a combination of the software and hardware. Further, in this embodiment, the storage 102 is stored in the non-volatile memory 11b.

Although the electronic apparatus 10 includes the storage 102 in FIG. 3, the storage 102 may be provided in an external device communicably connected to the electronic apparatus 10.

The image acquisition module 101 acquires an image (for example, still image) of a scene around the electronic apparatus 10 which is taken by the camera 13. It should be noted that the image acquired by the image acquisition module 101 includes, for example, various objects present around the electronic apparatus 10.

The storage 102 prestores an object pattern in which, for example, information concerning an object is defined.

The state estimation module 103 detects an object included in the image acquired by the image acquisition module 101 based on the object pattern stored in the storage 102. The state estimation module 103 estimates the state of the user wearing the electronic apparatus 10 based on the detected object.

The display controller 104 executes processing of displaying various types of information on the display 12. Even if the various types of information is displayed on the display 12, a display area in which the information is displayed includes fixed permeability. Further, the display controller 104 includes a function of controlling display of (the display area on) the display 12 (hereinafter referred to as an automatic display control function) based on the state of the user estimated by the state estimation module 103 (that is, an imaging result by the camera 13).

The operation acceptance module 105 includes a function of accepting an operation of the user to the electronic apparatus 10. The operation accepted by the operation acceptance module 105 includes, for example, an operation to the above-described touchsensor 14.

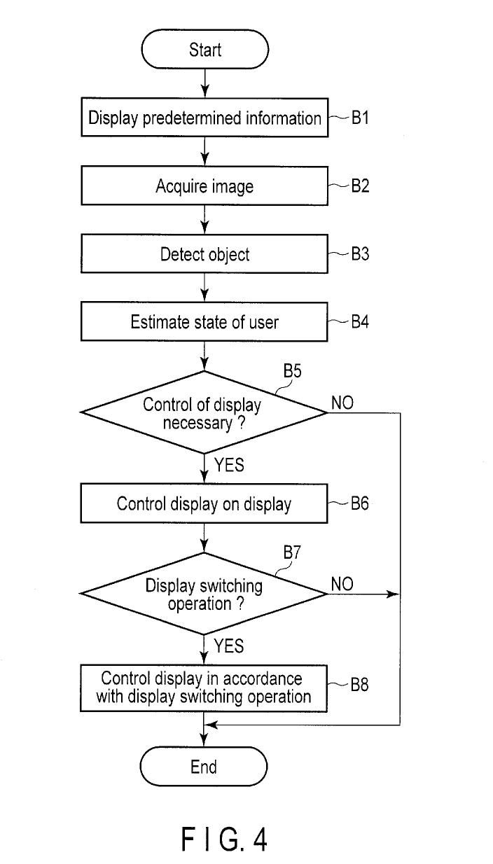

Next, processing procedures of the electronic apparatus 10 according to this embodiment will be described with reference to the flowchart of FIG. 4.

Here, predetermined information can be displayed on the display 12 in accordance with, for example, the operation of the user wearing the electronic apparatus 10 in the electronic apparatus 10 according to this embodiment (block B1).

The information displayed on the display 12 includes, for example, various types of information such as information of a motion picture, a web page, weather forecast and a map. Further, the display 12 is arranged in a position visually identified by the user if the electronic apparatus 10 is worn on the head of the user, as described above. Accordingly, if the user wears the electronic apparatus 10, the predetermined information is displayed (on the display 12) in front of the sight of the user, and the user can visually identify the displayed information without, for example, grasping the electronic apparatus 10 by hand.

It should be noted that the display 12 is constituted of, for example, a special lens, and the various types of information is projected on the display 12 by a projector (not shown) provided in, for example, the frame portion of the electronic apparatus (glasses-type wearable device) 10. This allows the various types of information to be displayed on the display 12. Although the information is displayed on the display 12 using the projector in this description, another structure can be adopted if the information can be displayed on the display 12.

Moreover, although the display 12 is supported by the lens portion corresponding to each of both eyes in the glasses shape as shown in FIG. 1, the various types of information may be displayed to be visually identified by both the eyes (that is, on both of the displays 12) or displayed to be visually identified by one of the eyes (that is, on only one of the displays 12).

If the predetermined information is displayed on the display 12 as described above, the image acquisition module 101 acquires an image of a scene around the electronic apparatus 10 taken by the camera 13 (for example, a scene in a sight direction of the user) (block B2). It should be noted that the image acquired by the image acquisition module 101 may be a still image or a moving image in this embodiment.

Next, the state estimation module 103 executes processing of detecting an object from the image acquired by the image acquisition module 101 (block B3).

In this case, the state estimation module 103 analyzes the image acquired by the image acquisition module 101, and applies the object pattern stored in the storage 102 to the analysis result.

Here, for example, information concerning an object arranged out of a house (on a street), an object arranged at home and a person (for example, a shape of the object) is defined as the object pattern stored in the storage 102. It should be noted that the object arranged out of a house includes, for example, a car, a building and various signs. Further, the object arranged at home includes, for example, furniture and a home electrical appliance. By using such an object pattern, the state estimation module 103 can detect an area corresponding to a shape, etc., defined as the object pattern in the image acquired by the image acquisition module 101 as an object (that is, the object arranged out of a house, the object arranged at home, the person, etc.). It should be noted that the object pattern stored in the storage 102 can be properly updated.

Next, the state estimation module 103 estimates the state of the user (state around the user) based on a detection result of an object (block B4). Specifically, the state estimation module 103 estimates that the user is out if the object arranged out of a house is detected from the image acquired by the image acquisition module 101. Further, the state estimation module 103 estimates that the user is at home if the object arranged at home is detected from the image acquired by the image acquisition module 101. If the state estimation module 103 estimates that the user is out, the state estimation module 103 detects a person (the number of persons) from the image acquired by the image acquisition module 101.

The display controller 104 determines whether the display on the display 12 needs to be controlled (changed) or not based on the state of the user estimated by the state estimation module 103 (block B5).

Here, if, for example, the user is out and a number of people are present around the user (that is, the user is in a crowd), the user's sight to surroundings is not sufficiently secured, which sometimes interrupts walk of the user, in a state where the predetermined information is displayed on the display 12. Thus, if the state estimation module 103 estimates that the user is out and a large number of people are detected by the state estimation module 103 (the number is larger than a preset value), the display controller 104 determines that the display on the display 12 needs to be controlled (restricted). If, for example, an object which may bring danger to the user is detected, it may be determined that the display on the display 12 needs to be controlled even if the user is not in a crowd.

On the other hand, if the state estimation module 103 estimates that the user is at home, the display controller 104 determines that the display on the display 12 need not be controlled.

If it is determined that the display on the display 12 needs to be controlled (YES in block B5), the display controller 104 controls the display (state) on the display 12 by the automatic display control function (block B6). It should be noted that the display control may be performed on both of the displays 12, or may be performed on only one of the displays 12.

The electronic apparatus 10 according to the embodiment performs controlling display of the display area by using the image of surroundings comprising a region which the user cannot see through at least a transparent part of the display area when the electronic apparatus 10 is worn on a body of the user.

Processing of controlling the display on the display 12 by the display controller 104 (automatic display control function) will be hereinafter described.

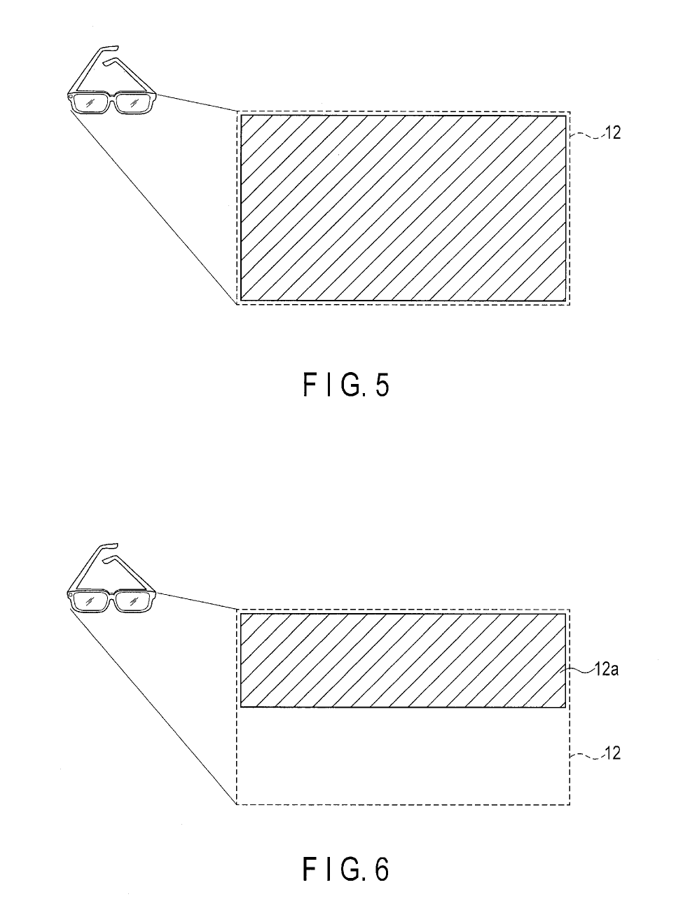

Here, a case where information is displayed in the whole area (screen) of the display 12 as shown in FIG. 5 is assumed. In this case, the display controller 104 performs control to change a display area (pattern) of information on the display 12 in order to, for example, secure a sight to surroundings which will not interrupt walk of the user (that is, to reduce an amount of information displayed on the display 12). FIGS. 6 to 10 show examples of display area patterns to be changed by the display controller 104. Here, first to fifth display area patterns will be described.

FIG. 6 shows the first display area pattern. As shown in FIG. 6, information is displayed only in area 12a which is the upper portion (or lower portion) relative to the center of the display 12 in the first display area pattern. Since no information is displayed in an area other than area 12a of the display 12, the first display area pattern allows the sight of the user from the area to surroundings to be secured.

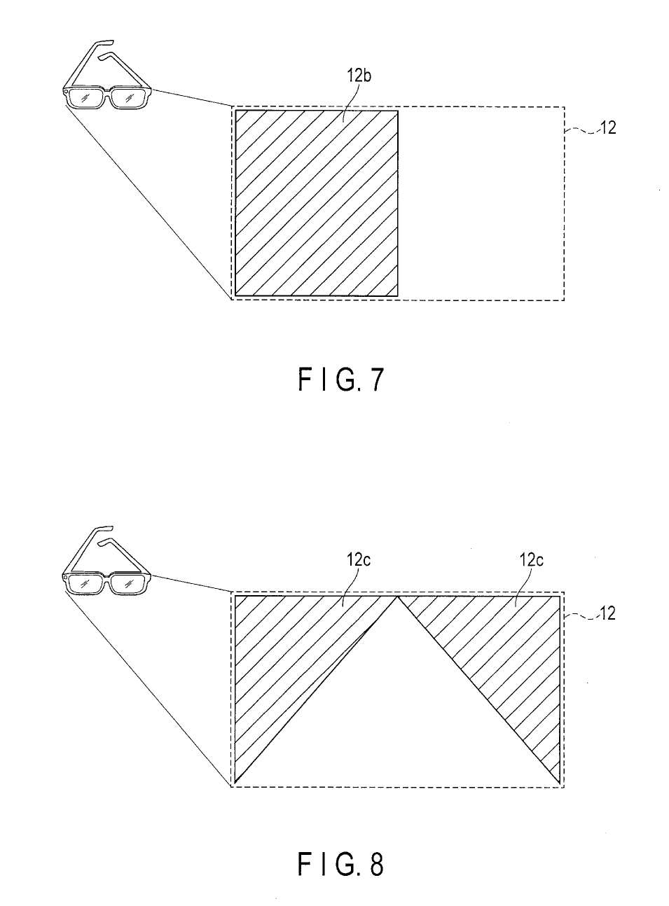

FIG. 7 shows the second display area pattern. As shown in FIG. 7, information is displayed only in area 12b which is the left portion (or right portion) relative to the center of the display 12 in the second display area pattern. Since no information is displayed in an area other than area 12b of the display 12, the second display area pattern allows the sight of the user from the area to surroundings to be secured.

It should be noted that area 12a shown in FIG. 6 and area 12b shown in FIG. 7 may be one-fourth as large in size as the display 12.

FIG. 8 shows the third display area pattern. As shown in FIG. 8, information is displayed only in areas 12c which are triangular and located in the upper portion of the display 12 in the third display area pattern. Since no information is displayed in an area other than areas 12c, the third display area pattern allows the sight of the user from the area to surroundings to be secured.

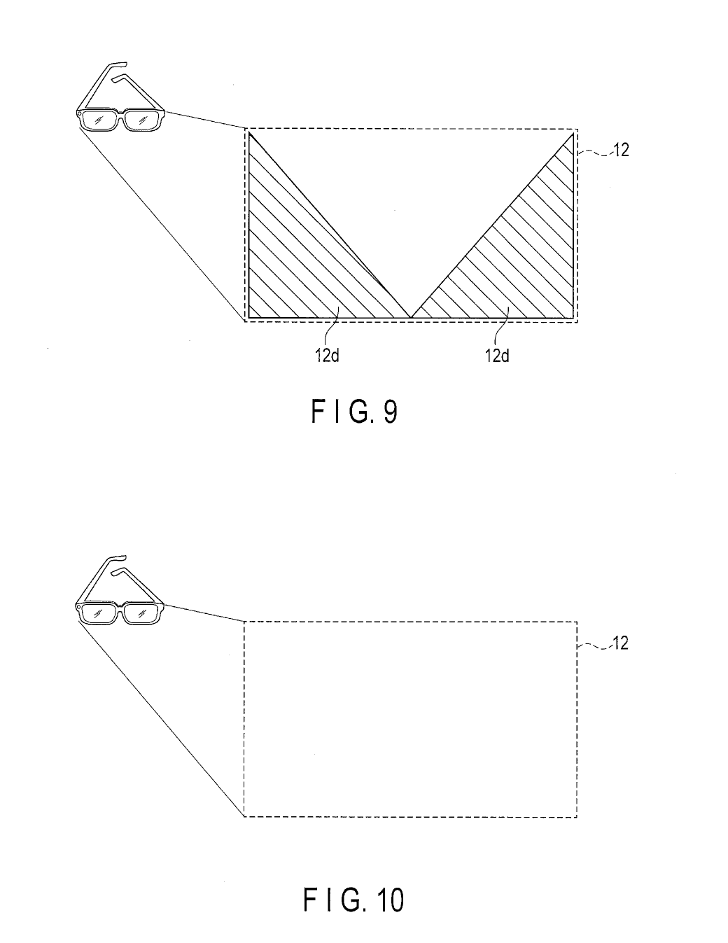

FIG. 9 shows the fourth display area pattern. As shown in FIG. 9, information is displayed only in areas 12d which are triangular and located in the lower portion of the display 12 in the fourth display area pattern. Since no information is displayed in an area other than areas 12d, the fourth display area pattern allows the sight of the user from the area to surroundings to be secured.

FIG. 10 shows a pattern of a fifth display area. As shown in FIG. 10, no information is displayed in the whole area of the display 12 in the fifth display area pattern (that is, display of information is turned off). The fifth display area pattern allows the sight of the user to surroundings to be secured in the whole area of the display 12.

According to the display area pattern, the sight of the user is secured in at least a part of a direction passing a display area having permeability when the electronic apparatus 10 is worn on part of a body of the user to be used.

It should be noted that the first to fifth display area patterns are kept in the display controller 104 in advance. Further, the display area patterns described above are examples, and other display area patterns may be kept.

If the user is in a crowd as described above, the display area of the display 12 as shown in FIG. 5 may be changed to any of the first to fifth display area patterns to secure the sight of the user to the surroundings. For example, it may be changed to a display area pattern in accordance with the number of persons detected by the state estimation module 103, etc. Specifically, if a small number of persons are detected by the state estimation module 103 (the number is smaller than a preset value), it may be changed to the first to fourth display area patterns, and if a large number of persons are detected (the number is larger than the preset value), it may be changed to the fifth display area pattern.

Further, other than the change to the display area patterns kept in the display controller 104 in advance as described above, information may be displayed, for example, only in an area in which no person is detected. Moreover, even if the state estimation module 103 estimates, for example, that the user is at home, it can be estimated that the user views a TV when the TV is detected from an image by the state estimation module 103. Thus, information can also be displayed only in an area in which the TV is not detected.

Here, if a display area pattern is changed in a state where information is displayed in the whole area of the display 12 as shown in FIG. 5, an amount of information which can be displayed is reduced in comparison with the case where the information is displayed in the whole area. Thus, in this embodiment, the display controller 104 performs control to change content of information displayed on the display 12 (that is, display content of the display 12) in accordance with the change of the display area pattern.

Specifically, if a plurality of information items are displayed in the whole area of the display 12, for example, a preference of the user is analyzed and priority for each information item is determined in accordance with the analysis result. This allows the determined information item with high priority to be displayed on the display 12 (or in the display area of the display 12). It should be noted that information necessary to analyze the preference of the user may be kept in, for example, the electronic apparatus 10, or may be acquired from an external device.

Further, although a display area pattern is changed in this description, control to change display content of the display 12 may be performed without changing the display area pattern.

Specifically, if the user is in a crowd (that is, it is necessary to pay attention to surroundings), information to call attention, for example, “crowded” may be displayed. Similarly, if a motion picture including a caption is displayed on the display 12 when the user is in a crowd, the caption may be automatically turned off.

Further, when the state of the user is estimated, for example, a matter to which attention should be paid around the user may be preferentially displayed by acquiring a present location of the user using, for example, the Global Positioning System (GPS). It should be noted that the matter to which attention should be paid around the user can be acquired from regional information of the present location of the user, etc.

Further, in a state of emergency such as an earthquake, information concerning the emergency (for example, emergency news report) may be displayed in preference to other information (for example, display of other information is turned off).

Moreover, when the information to call attention and that concerning emergency are displayed, a display form can be changed (for example, a color can be changed), or characters can be enlarged in consideration of, for example, a human visual feature and a color of a surrounding scene.

Although a case where the display controller 104 changes a display area (pattern) or display content of information on the display 12 is mainly described, other control (processing) may be performed in the electronic apparatus 10 according to this embodiment if the display on the display 12 is controlled (changed) in accordance with, for example, the state of the user estimated by the state estimation module 103. If information is displayed to be visually identified with, for example, both eyes (that is, on both of the displays 12), the display may be changed (controlled) to display the information to be visually identified with an eye (that is, on one of the displays 12). The same is true of each of the following embodiments.

Even if the display on the display 12 is changed (controlled) in accordance with the state of the user estimated by the state estimation module 103 as described above, the change (that is, display control) is sometimes unnecessary for the user. Specifically, for example, even if a number of people are present around the user, the control of the display on the display 12 as described above is often unnecessary if the user does not walk. In such a case, the user can perform a predetermined operation (hereinafter referred to as a display switching operation) on the electronic apparatus 10 to switch the display on the display 12 (that is, return it to a state before the processing of block B6 is executed). It should be noted that the display switching operation performed on the electronic apparatus 10 by the user is accepted by the operation acceptance module 105.

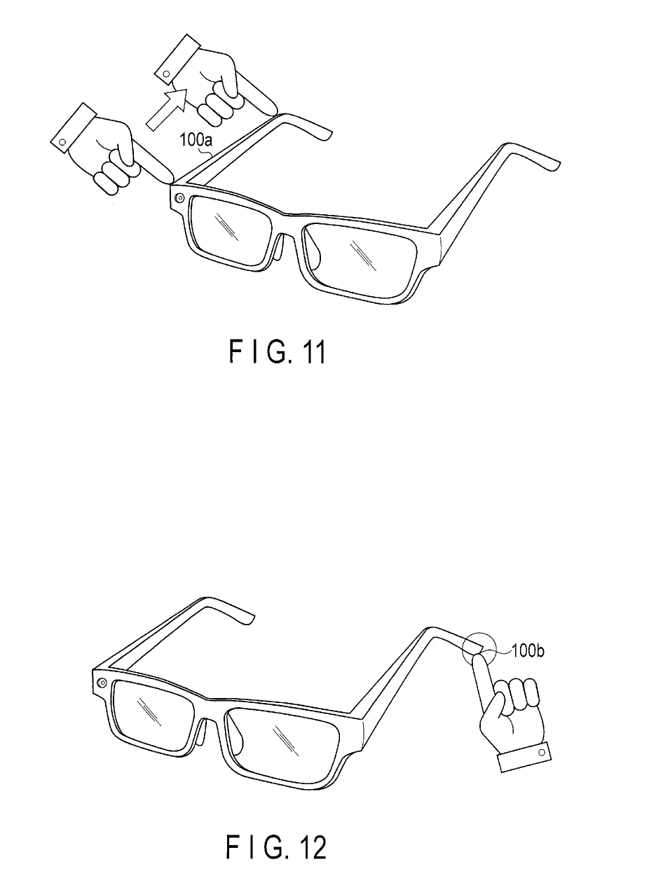

Examples of display switching operations performed on the electronic apparatus 10 will be hereinafter described with reference to FIGS. 11 to 19. Here, first to ninth operations will be described as examples of the display switching operations performed on the electronic apparatus 10.

Here, as described above, the touchsensor (for example, touchpanel) 14 is provided in the frame portion of the electronic apparatus 10 in this embodiment. Thus, contact (position) of a finger, etc., of the user with the frame portion, a moving direction of the contact position, etc., can be detected in the electronic apparatus 10. Accordingly, for example, each of operations described below can be detected in the electronic apparatus 10.

In the following description, of the frame portion of the electronic apparatus 10, a portion supporting a lens (the display 12) is referred to as a front (portion) and a portion including ear hooks which is other than the front portion is referred to as a temple (portion). Further, when the electronic apparatus 10 is worn, a temple portion located on the right side of the user is referred to as a right temple portion, and that located on the left side of the user is referred to as a left temple portion.

FIG. 11 is a figure for describing the first operation. In the first operation, a finger is shifted (slid) along a right temple portion 100a with the finger in contact with, for example, the right temple portion 100a of the electronic apparatus 10, as shown in FIG. 11. In other words, the right temple portion 100a is stroked with the finger in the first operation. Although the finger is shifted from the front side to the ear hook side in the example shown in FIG. 11, the finger may be shifted in an opposite direction in the first operation. Moreover, although the first operation is performed on the right temple portion 100a in the example shown in FIG. 11, it may be performed on the left temple portion.

FIG. 12 is a figure for describing the second operation. In the second operation, a finger is brought into contact with a tip 100b of the left temple portion of the electronic apparatus 10, as shown in FIG. 12. In other words, the tip 100b of the left temple portion is tapped in the second operation. Although the second operation is performed on the tip 100b of the left temple portion in the example shown in FIG. 12, it may be performed on the tip of the right temple portion.

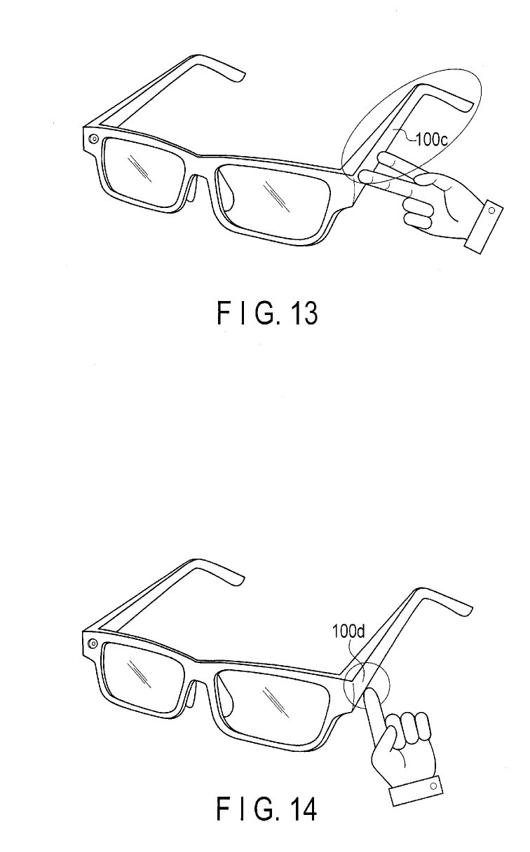

FIG. 13 is a figure for describing the third operation. At least one finger (for example, two fingers) is brought into contact with a left temple portion 100c of the electronic apparatus 10 at the same time in the third operation, as shown in FIG. 13. In other words, the left temple portion 100c is touched with at least one finger at the same time in the third operation. Although the third operation is performed on the left temple portion 100c in the example shown in FIG. 13, it may be performed on the right temple portion.

FIG. 14 is a figure for describing the fourth operation. A finger is brought into contact with (proximity of) a contact portion 100d between the front portion and the left temple portion of the electronic apparatus 10 in the fourth operation, as shown in FIG. 14. In other words, the contact portion 100d is picked from bottom up with the finger in the fourth operation. Although the fourth operation is performed on the contact portion 100d between the front portion and the left temple portion in the example shown in FIG. 14, it may be performed on a contact portion between the front portion the right temple portion.

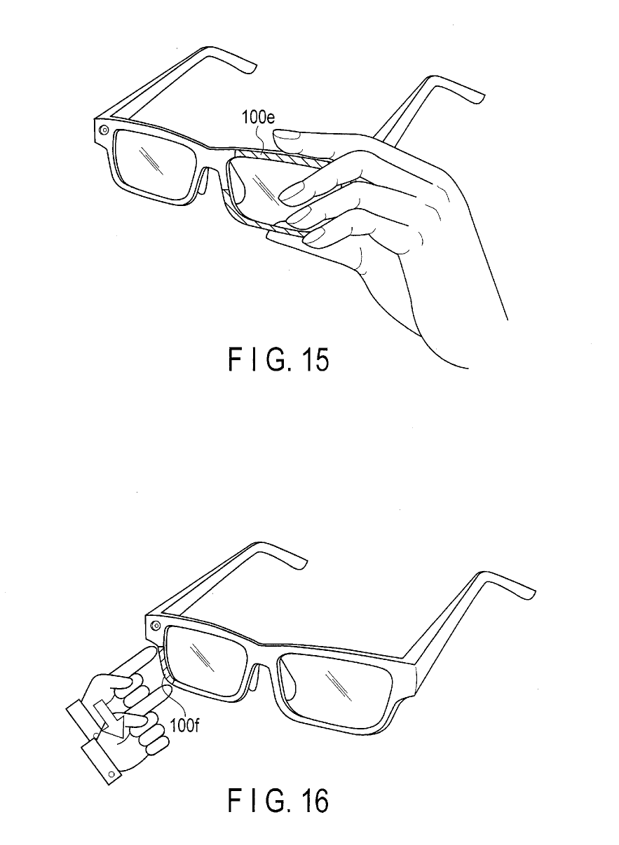

FIG. 15 is a figure for describing the fifth operation. Two fingers are brought into contact with (upper and lower sides of) a front portion 100e of the electronic apparatus 10 in the fifth operation, as shown in FIG. 15. In other words, the front portion 100e is pinched with the forefinger and thumb to be grasped or touched in the fifth operation. Although, in the example shown in FIG. 15, the fifth operation is performed on a front portion supporting a lens corresponding to a left eye (left lens frame portion), it may be performed on a front portion supporting a lens corresponding to a right eye (right lens frame portion).

FIG. 16 is a figure for describing the sixth operation. A finger is shifted (slid) along portion 100f located from just beside the exterior of the right lens frame portion of the electronic apparatus 10 to the lower right of the right lens frame portion with the finger in contact with portion 100f in the sixth operation, as shown in FIG. 16. In other words, portion 100f is stroked in the sixth operation. Although the finger is shifted from top down in the example shown in FIG. 16, the finger may be shifted in an opposite direction in the sixth operation. Moreover, although the sixth operation is performed on the right lens frame portion in the example shown in FIG. 16, it may be performed on the left lens frame portion.

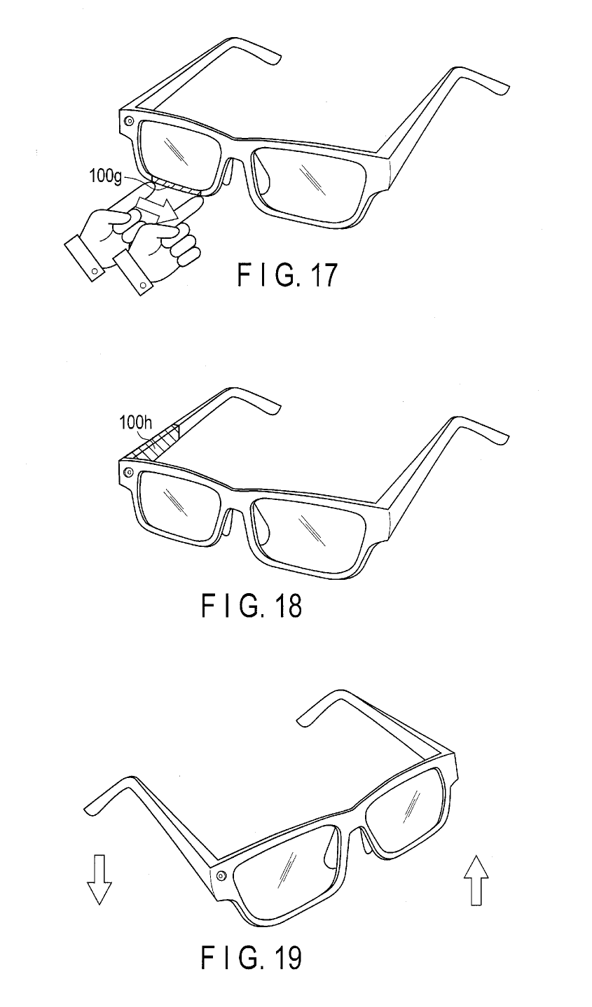

FIG. 17 is a figure for describing the seventh operation. A finger is shifted (slid) along portion 100g at the bottom of the exterior of the right lens frame portion of the electronic apparatus 10 with the finger in contact with portion 100g in the seventh operation, as shown in FIG. 17. In other words, portion 100g is stroked in the seventh operation. Although the finger is shifted from right to left in the example shown in FIG. 17, the finger may be shifted in an opposite direction in the seventh operation. Moreover, although the seventh operation is performed on the right lens frame portion in the example shown in FIG. 17, it may be performed on the left lens frame portion.

FIG. 18 is a figure for describing the eighth operation. At least two fingers are brought into contact with (upper and lower sides of) portion 100h near the front portion of the right temple portion of the electronic apparatus 10 (that is, the right lens frame portion) in the eighth operation, as shown in FIG. 18. In other words, portion 100h is pinched with the forefinger and thumb, or the forefinger, middle finger and thumb to be grasped or touched in the eighth operation. Although the eighth operation is performed on the right temple portion, it may be performed on the left temple portion.

Although the first to eighth operations can be detected by the touchsensor 14 provided in the frame portion of the electronic apparatus 10, the operation performed on the electronic apparatus 10 may be detected by other sensors, etc.

FIG. 19 is a figure for describing the ninth operation. The frame portion of the electronic apparatus 10 is grasped with, for example, both hands, and (the frame portion of) the electronic apparatus 10 is tilted in the ninth operation, as shown in FIG. 19. If the ninth operation is performed, the electronic apparatus 10 includes a sensor configured to detect a tilt of the electronic apparatus 10. For example, an acceleration sensor, a gyro sensor, etc., may be utilized as the sensor configured to detect the tilt of the electronic apparatus 10. Although the electronic apparatus 10 is tilted such that the right lens frame portion (right temple portion) is lowered and the left lens frame portion (left temple portion) is raised (that is, the electronic apparatus 10 is tilted to the right) in the example shown in FIG. 19, the electronic apparatus 10 may be tilted such that the right lens frame portion (right temple portion) is raised and the left lens frame portion (left temple portion) is lowered (that is, the electronic apparatus 10 is tilted to the left) in the ninth operation.

In this embodiment, for example, at least one of the first to ninth operations is specified as a display switching operation.

It should be noted that the first to ninth operations are just examples and other operations may be specified as a display switching operation. As the other operations, for example, a nail of the user may be brought into contact with the frame portion of the electronic apparatus 10, or a finger may be alternately brought into contact with the right temple portion and the left temple portion of the electronic apparatus 10.

Moreover, an operation by eyes of the user wearing the electronic apparatus 10 may be performed as a display switching operation by attaching a sensor for detecting the eyes to, for example, (an inside of) the frame portion of the electronic apparatus 10. Although, for example, a camera configured to image eye movement of the user can be used as the sensor for detecting the eyes of the user, other sensors such as a sensor in which infrared rays are utilized may be used. In this case, an operation of, for example, shifting eyes to the right (or to the left) can be a display switching operation. Moreover, an operation by a blink of the user (by the number of blinks, etc.) can be a display switching operation.

Further, although (at least one of) the first to ninth operations are display switching operations in this description, the first to ninth operations may be performed as normal operations to the electronic apparatus 10.

Specifically, the first operation of stroking the temple portion of the electronic apparatus 10 from the front side to the ear hook side (in a first direction) with a finger, which is described in FIG. 11, may be performed as an operation indicating “scroll”. “Scroll” includes, for example, scrolling display content (display screen) of the display 12. On the other hand, the first operation of stroking the temple portion of the electronic apparatus 10 from the ear hook side to the front side (in a second direction) with a finger may be performed as an operation indicating “close a display screen”. That is, different operations can be accepted in accordance with the direction in which the temple portion of the electronic apparatus 10 is stroked.

Further, the second operation of tapping the tip of the right temple portion of the electronic apparatus 10, which is described in FIG. 12, may be performed as an operation indicating, for example, “yes/forward”. On the other hand, the second operation of tapping the tip of the left temple portion of the electronic apparatus 10 may be performed as an operation indicating, for example, “no/back”. It should be noted that “yes” includes, for example, permitting the operation of the electronic apparatus 10 concerning the display on the display 12. On the other hand, “no” includes, for example, refusing the operation of the electronic apparatus 10 concerning the display on the display 12. Further, “forward” includes displaying a next page in a case where web pages, etc., consisting of a plurality of pages are displayed on the display 12. On the other hand, “back” includes displaying a previous page in a case where web pages, etc., consisting of a plurality of pages are displayed on the display 12.

Further, the third operation of touching the temple portion of the electronic apparatus 10 with two fingers at the same time, which is described in FIG. 13, may be performed as an operation indicating, for example, “yes/forward”. On the other hand, the third operation of touching the temple portion of the electronic apparatus 10 with one finger may be performed as an operation indicating, for example, “no/back”.

Further, the fourth operation of picking the contact portion between the front portion and the temple portion of the electronic apparatus 10 from bottom up with a finger, which is described in FIG. 14, may be performed as an operation indicating, for example, “yes/forward/information display ON/scroll”. On the other hand, the fourth operation of picking the contact portion between the front portion and the temple portion of the electronic apparatus 10 from top down with a finger may be performed as an operation indicating, for example, “no/back/information display OFF”. It should be noted that “information display on” includes turning on display of information on the display 12, starting reproducing a motion picture, etc. On the other hand, “information display OFF” includes turning off display of information on the display 12, stopping reproducing a motion picture, etc.

Further, the fifth operation of pinching the front portion of the electronic apparatus 10 with the forefinger and thumb once to grasp it, which is described in FIG. 15, may be performed as an operation indicating, for example, “information display ON”. On the other hand, the fifth operation of pinching the front portion of the electronic apparatus 10 with the forefinger and thumb twice to grasp it may be performed as an operation indicating, for example, “information display OFF”. Moreover, the fifth operation of pinching the front portion of the electronic apparatus 10 with both hands may be performed as an operation indicating, for example, “power on/off”.

Further, the sixth operation of stroking a portion located from just beside the exterior of the right lens frame portion of the electronic apparatus 10 to the lower right of the right lens frame portion from top down with a finger, which is described in FIG. 16, may be performed as an operation indicating, for example, “downward or leftward scroll”. On the other hand, the sixth operation of stroking a portion located from just beside the exterior of the right lens frame portion of the electronic apparatus 10 to the lower right from bottom up with a finger may be performed as an operation indicating, for example, “upward or rightward scroll”. Although the sixth operation performed on the right lens frame portion is described, the same is true of the sixth operation performed on the left lens frame portion. Moreover, operations of picking the portion located from just beside the exterior of the right (or left) lens frame portion to the lower right once, picking it twice, releasing it after touching it for approximately 0.2 to 1 second, etc., can be an operation indicating, for example, “yes/forward/information display ON” and “no/back/information display OFF”.

Further, the seventh operation of stroking a portion at the bottom of the exterior of the right lens frame portion of the electronic apparatus 10 from right to left with a finger, which is described in FIG. 17, may be performed as an operation indicating, for example, “downward or leftward scroll”. On the other hand, the seventh operation of stroking a portion at the bottom of the exterior of the right lens frame portion of the electronic apparatus 10 from left to right with a finger may be performed as an operation indicating, for example, “upward or rightward scroll”. Although the seventh operation performed on the right lens frame portion is described, the same is true of the seventh operation performed on the left lens frame portion. Moreover, operations of picking part of the portion at the bottom of the exterior of the right (or left) lens frame portion once, picking it twice, releasing it after touching it for approximately 0.2 to 1 second, etc., can be an operation indicating, for example, “yes/forward/information display ON” and “no/back/information display OFF”.

Moreover, if the eighth operation of pinching a portion near the front portion of the right temple portion of the electronic apparatus 10 with the forefinger and thumb to grasp it, which is described in FIG. 18, is performed, operations of picking the portion with one of the forefinger and thumb once, pick it twice, releasing it after touching it for approximately 0.2 to 1 second, keeping the one finger released, etc., can be an operation indicating, for example, “yes•no/forward•back/information display ON•OFF/upward•downward scroll/rightward•leftward scroll”.

Similarly, also in a case where the eighth operation of pinching a portion near the front portion of the right temple portion of the electronic apparatus 10 with the forefinger, middle finger and thumb to grasp it, operations of picking the portion with one of the forefinger, middle finger and thumb once, picking it twice, releasing it after touching it for approximately 0.2 to 1 second, keeping the one finger released, etc., can be an operation indicating, for example, “yes•no/forward•back/information display ON•OFF/upward•downward scroll/rightward•leftward scroll”.

Further, the ninth operation of tilting the electronic apparatus 10 to the right, which is described in FIG. 19, may be performed as an operation indicating, for example, “yes/forward/information display ON”. On the other hand, the ninth operation of tilting the electronic apparatus 10 to the left may be performed as an operation indicating, for example, “no/back/information display OFF”.

If the above-described operation by the user's eyes is performed, an operation of shifting the user's eyes, for example, to the right (that is, causing the user to slide a glance to the right) can be an operation indicating “yes/forward/information display ON”, and an operation of shifting the user's eyes to the left (that is, causing the user to slide a glance to the left) can be an operation indicating “no/back/information display OFF”. Moreover, an operation of causing the user to slowly blink (slowly close eyes) can be an operation indicating “yes/forward/information display ON”, and an operation of causing the user to quickly blink twice (quickly close eyes twice) can be an operation indicating “no/back/information display OFF”.

Referring to FIG. 4, the operation acceptance module 105 determines whether the display switching operation is accepted or not (block B7).

If it is determined that the display switching operation is accepted (YES in block B7), the display controller 104 controls the display on the display 12 in accordance with the operation (block B8). Specifically, the display controller 104 performs control to return (switch) the display state of the display 12 (display area and display content) to a state before the processing of block B6 is executed. Further, other display control may be performed in accordance with the display switching operation.

If the processing of block B8 is executed, the automatic display control function of the display controller 104 may be disabled for a certain period or turned off. If the automatic display control function is disabled for a certain period, the automatic display control function can be automatically reutilized after the certain period passes. On the other hand, if the automatic display control function is turned off, the automatic display control function cannot be utilized until, for example, the user explicitly turns on the automatic display control function.

If it is determined that the display on the display 12 need not be controlled in block B5 (NO in block B5), the processing after block B6 is not executed, and the display state of the display 12 by the processing of block B1 is maintained.

Similarly, if it is determined that the display switching operation is not accepted in block B7 (NO in block B8), the processing of block B8 is not executed, and the display state of the display 12 by the processing of block B6 is maintained.

The processing shown in FIG. 4 allows the display on the display 12 to be controlled in accordance with (the state of the user estimated based on) an imaging result by the camera 13.

After control of restricting the display on the display 12 is performed, control of removing the restriction may be performed. Specifically, a case where it is determined that the display on the display 12 need not be restricted (that is, a case where a state where the display on the display 12 needs to be restricted is solved) if the processing shown in FIG. 4 is re-executed after, for example, the display area pattern of the display 12 is changed to the first to fifth display area patterns is assumed. In this case, the display on the display 12 can be controlled to be returned to a state before the display on the display 12 is restricted based on, for example, a history of information displayed on the display 12 (for example, information can be displayed in the whole area of the display 12). The processing (after block B2) shown in FIG. 4 may be regularly executed, or may be executed if an instruction is given by the user.

Further, even if, for example, the user is in a crowd (that is, the number of persons acquired by the state estimation module 103 is large), it is also possible not to restrict the display on the display 12 if it is determined that persons around the user do not move much (for example, if they sit on chairs and stand by in a waiting room, etc.) by analyzing, for example, an image (here, for example, moving image) taken by the camera 13.

Although the camera 13 is used to estimate the state of the user in FIG. 4, sensors other than the camera 13 may be used. Specifically, GPS may be used to estimate, for example, whether the user is out or not. In this case, it is possible to estimate that the user is out if, for example, the present location of the user acquired by GPS is different from the position, etc., of the house of the user.

Further, a microphone configured to detect sound (voice) of surroundings may be used to estimate, for example, whether the user is in the crowd or not. In this case, it is possible to estimate, for example, that the user is in the crowd, because living sound, traffic noise, etc., can be recognized by analyzing, for example, ambient sound detected by the microphone (spectrum pattern of background sound).

Moreover, a photodiode may be used to estimate the state of the user. The camera 13 and another sensor are preferably used in combination because the state of the user is sometimes difficult to estimate in detail based on only the information from the photodiode.

Although the GPS antenna, the microphone and the photodiode are described as examples of other sensors, sensors other than them may be used. If the camera 13 and other sensors are used in combination, estimation accuracy of the state of the user can be improved.

It is sometimes difficult to keep the camera 13 working in view of the energy consumption of the electronic apparatus 10. Thus, the camera 13 may be started, for example, only when the state of the user cannot be estimated only based on information detected by sensors other than the camera 13. Further, the camera 13 may be started when change of the state around the user is detected using sensors other than the camera 13. The change of the state around the user can be detected when it is determined that the user moves by a distance greater than or equal to a preset value (threshold value) based on, for example, position information acquired by GPS. Further, the change of the state around the user can be detected based on change of brightness, a color, etc., acquired by the photodiode. Such a structure allows the energy consumption of the electronic apparatus 10 to be reduced.

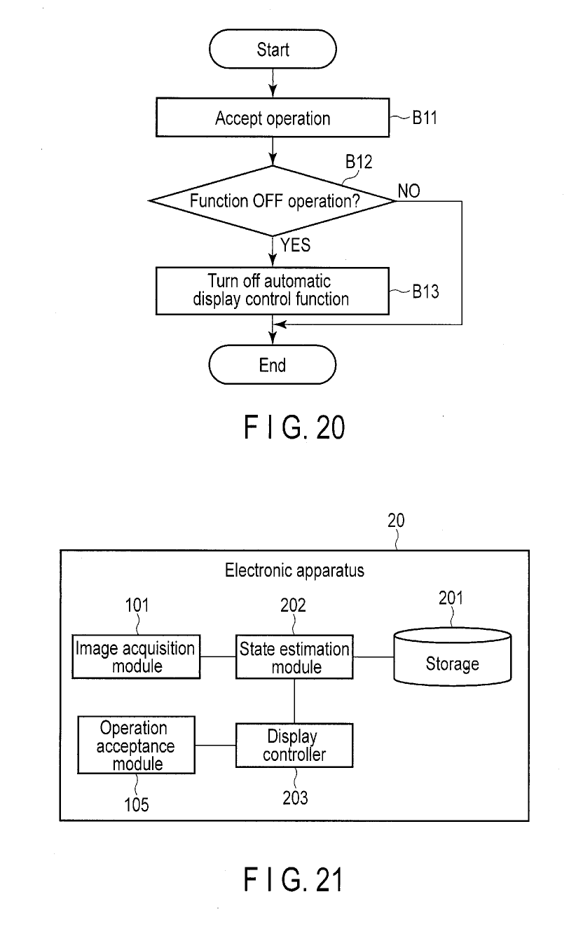

Here, in the electronic apparatus 10 according to this embodiment, the user can turn off (that is, manually remove) the automatic display control function in advance by operating the electronic apparatus 10. Processing procedures of the electronic apparatus 10 when the automatic display control function is turned off will be described with reference to the flowchart of FIG. 20.

First, the operation acceptance module 105 accepts an operation performed on the electronic apparatus 10 by the user (block Ell).

Then, the operation acceptance module 105 determines whether or not the accepted operation is an operation for turning off the automatic display control function (hereinafter referred to as a function OFF operation) (block B12). It should be noted that the function OFF operation is specified in advance, and, for example, at least one of the first to ninth operations can be the function OFF operation.

If it is determined that the accepted operation is the function OFF operation (YES in block B12), the display controller 104 turns off the automatic display control function (block B13). If the automatic display control function is turned off in this manner, the processing after block B2 shown in FIG. 4 is not executed as described above even if the predetermined information is displayed on the display 12 in accordance with the operation of the user wearing the electronic apparatus 10, and the display state is maintained. This prevents the automatic display control function from being operated despite the user's intention.

On the other hand, if it is determined that the accepted operation is not the function OFF operation, the processing of block B13 is not executed. In this case, the processing according to the operation accepted by, for example, the operation acceptance module 105 is executed in the electronic apparatus 10.

A case where the automatic display control function is turned off is described. However, for example, if an operation similar to the function OFF operation is accepted in a state where the automatic display control function is turned off, the automatic display control function can be turned on. It should be noted that the operation for turning on the automatic display control function may be an operation different from the function OFF operation.

As described above, in this embodiment, the display on the display 12 is controlled in accordance with the imaging result around the user by the camera 13 (imaging device), and the display area or display content of the display 12 can be changed (restricted) in accordance with the state of the user, for example, the user being in a crowd. This prevents the display of the information on the display 12 from disturbing walk of the user. Thus, the user can walk safely, and the safety of the user wearing the electronic apparatus 10, people around the user, etc., can be ensured. Moreover, since control of automatically returning the display on the display 12 to an original state can be performed in this embodiment if a state where the display on the display 12 needs to be restricted is solved, display can be appropriately performed in accordance with the state of the user.

Further, in this embodiment, since an operation to the frame portion, etc., of the electronic apparatus 10 can be performed as an operation of switching the display on the display 12, an operation of turning off the automatic display control function and another normal operation to the electronic apparatus 10, operability of the electronic apparatus (glasses-type wearable appliance) 10 can be improved.

Moreover, in this embodiment, the state of the user can be suitably estimated using the camera 13 and a sensor such as the GPS antenna and the microphone.

Although the processing described in this embodiment is executed in the electronic apparatus 10 in this description, the electronic apparatus 10 may operate as a display device, and the above processing may be executed in an external device (for example, smartphone, tablet computer, personal computer or server device) communicably connected to the electronic apparatus 10. Further, although the electronic apparatus 10 according to this embodiment is mainly a glasses-type wearable device in this description, this embodiment can be applied to, for example, an electronic apparatus in which a display is arranged in a position visually identified by the user when worn on the user (that is, display needs to be controlled in accordance with the state of the user, etc.).

### Second Embodiment

Next, a second embodiment will be described. FIG. 21 is a block diagram mainly showing a functional configuration of an electronic apparatus according to this embodiment. In FIG. 21, portions similar to those in FIG. 3 are denoted by the same reference numbers, and detailed description thereof will be omitted. Here, portions different from those in FIG. 3 will be mainly described. Further, since an outer appearance and a system configuration of the electronic apparatus according to this embodiment are the same as those in the first embodiment, they will be properly described using FIGS. 1 and 2.

This embodiment is different from the first embodiment in that the state (action) of the user wearing the electronic apparatus 10 is estimated based on the imaging result by the camera 13.

As shown in FIG. 21, an electronic apparatus 20 according to this embodiment includes a storage 201, a state estimation module 202 and a display controller 203.

In this embodiment, the storage 201 is stored in the non-volatile memory 11b. It should be noted that the storage 201 may be provided in, for example, an external device communicably connected to the electronic apparatus 10.

Further, in this embodiment, all or part of the state estimation module 202 and the display controller 203 may be realized by software, may be realized by hardware, or may be realized as a combination of the software and hardware.

The storage 201 prestores state estimation information in which, for example, the state of the user estimated from an amount of movement in a moving image is defined.

The state estimation module 202 estimates the state of the user wearing the electronic apparatus 10 based on the image acquired by the image acquisition module 101 and the state estimation information stored in the storage 201.

The display controller 203 includes a function (automatic display control function) of controlling the display (state) on the display 12 based on the state of the user estimated by the state estimation module 202 (that is, imaging result by the camera 13).

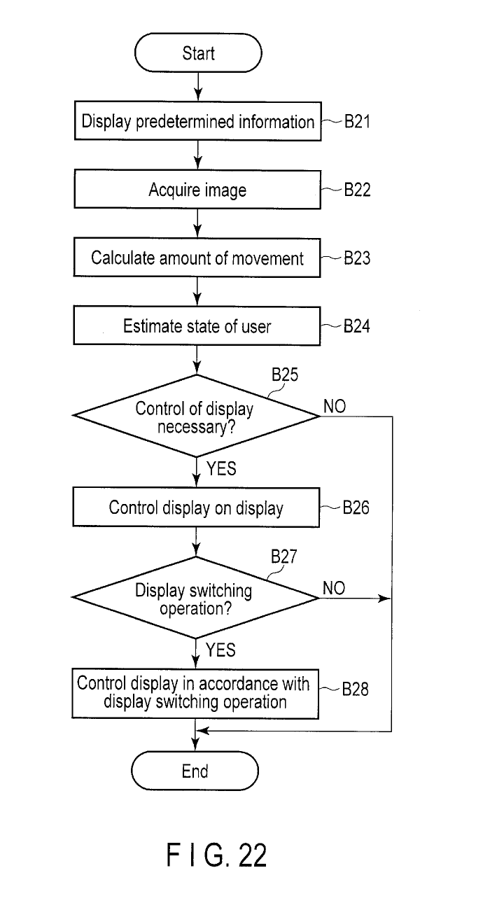

Next, processing procedures of the electronic apparatus 20 according to this embodiment will be described with reference to the flowchart of FIG. 22.

First, processing of blocks B21 and B22 equivalent to the processing of blocks B1 and B2 shown in FIG. 4 is executed. It should be noted that the image acquired by the image acquisition module 101 in block B22 is a moving image.

Next, the state estimation module 202 calculates the amount of movement in the moving image acquired by the image acquisition module 101 from a plurality of frames constituting the moving image (block B23). Specifically, the state estimation module 202 calculates the amount of movement based on, for example, a position of a specific object between the frames constituting the moving image acquired by the image acquisition modyle 101. The amount of movement calculated by the state estimation module 202 allows, for example, a moving direction and a moving amount (moving speed) of the user to be obtained.

The state estimation module 202 estimates the state of the user based on the calculated amount of movement (moving direction and moving amount) and the state estimation information stored in the storage 201 (block B24).

Here, the state of the user estimated from, for example, each of a plurality of prepared amounts of movement (moving direction and moving amount) is defined in the state estimation information stored in the storage 201. It should be noted that the state of the user which can be estimated by the state estimation information includes, for example, a state where the user is on a moving vehicle, a state where the user is walking and a state where the user is running.

The use of such state estimation information allows the state estimation module 202 to specify the state of the user estimated from (an amount of movement equal to) the calculated amount of movement.

In the processing of block B24, the state where the user is on a moving vehicle is estimated if the amount of movement equivalent to, for example, that of movement at dozens of kilometers per hour in the sight direction of the user is calculated. Moreover, the state where the user is walking is estimated if the amount of movement equivalent to, for example, that of movement at approximately four to five kilometers per hour in the sight direction of the user is calculated. Further, the state where the user is running is estimated if the amount of movement equivalent to, for example, that of movement at approximately ten kilometers per hour in the sight direction of the user is calculated.

The state of the user estimated by the state estimation module 202 may be states other than those described above. Specifically, if an amount of movement (moving direction and moving amount) equivalent to that of movement in a vertical direction is calculated, for example, a state where the user is on a vehicle moving in a vertical direction such as an elevator or an escalator, or a state where the user is doing bending and stretching exercises can be estimated in accordance with the moving amount.

Since the state of the user is estimated based on the amount of movement calculated from the moving image taken by the camera 13 in this embodiment, a moving image sufficient to calculate the amount of movement from which the moving direction and moving amount of the user can be obtained needs to be taken to estimate, for example, the state where the user is on a moving vehicle.

Further, although the state where the user is on a vehicle can be estimated from the amount of movement calculated from the moving image taken by the camera 13, the type of vehicle is difficult to estimate. In this case, the user can be caused to register the type of vehicle (for example, car or train). Moreover, a vehicle containing the user may be specified based on a scene around the user included in the moving image by analyzing the moving image taken by the camera 13.

The state estimation information stored in the storaget 201 can be properly updated.

Next, the display controller 203 determines whether the display on the display 12 needs to be controlled (changed) or not based on the state of the user estimated by the state estimation module 202 (block B25).

Here, if, for example, the user is on a vehicle (for example, the user drives a car) in a state where information is displayed on the display 12, the user's sight to the surroundings is not sufficiently secured, or the user cannot concentrate on driving. Then, an accident, etc., may be caused. Further, the state where information is displayed on the display 12 may cause a collision, etc., with a person or an object around the user as well as when the user is walking or running. Accordingly, if the state where the user is on a vehicle, the state where the user is walking or the state where the user is running is estimated by the state estimation module 202, the display controller 203 determines that the display on the display 12 needs to be controlled (restricted). On the other hand, if the user is on, for example, a train or a bus, an accident or a collision is not likely to be caused. Thus, even if, for example, the state where the user is on a vehicle is estimated by the state estimation module 202, the display controller 203 determines that the display on the display 12 need not be controlled if the train, bus or the like is registered by the user as a type of vehicle.

If it is determined that the display on the display 12 needs to be controlled (YES in block B25), the display controller 203 controls the display on the display 12 by the automatic display control function (block B26). Since the processing of controlling the display on the display 12 by the display controller 203 is similar to that in the first embodiment, detailed description thereof will be omitted. That is, the display controller 203 performs control to, for example, change a display area (pattern) or display content of information on the display 12.

Here, the display area of the display 12 may be changed to, for example, any of the first to fifth display area patterns to secure the user's sight to the surroundings; however, it may be changed to a different display area pattern in accordance with the state of the user estimated by the state estimation module 202. Specifically, if the state of the user estimated by the state estimation module 202 is on a vehicle, the user may, for example, drive a car. In this case, the display area of the display 12 may be changed to, for example, the first display area pattern in which information is displayed only in an area lower than the center of the display 12 to secure a sight which will not interfere with driving of a car. Further, the display area of the display 12 may be changed to the fifth display area pattern (that is, display of information is turned off) to further improve safety. On the other hand, if the state of the user estimated by the state estimation module 202 is walking or running, the display area of the display 12 may be changed to, for example, the first display area pattern in which information is displayed only in an area located above the center of the display 12, or the third display area pattern in which information is displayed in triangle areas located in the upper part of the display 12, to secure the sight around the user's feet.

As described above, when the processing of block B26 is executed, the processing of blocks B27 and B28 equivalent to that of blocks B7 and B8 shown in FIG. 4 is executed. Since the display switching operation of blocks B27 and B28 is similar to that in the first embodiment, detailed description thereof will be omitted.

If it is determined that the display on the display 12 need not be controlled in block B25 (NO in block B25), the processing after block B26 is not executed, and the display state of the display 12 by the processing of block B21 is maintained.

Similarly, if it is determined that the display switching operation is not accepted in block B27 (NO in block B27), the processing of block B28 is not executed, and the display state of the display 12 by the processing of block B26 is maintained.

The processing shown in FIG. 22 allows the display on the display 12 to be controlled in accordance with (the state of the user estimated based on) the imaging result by the camera 13.

After control of restricting the display on the display 12 is performed, control of removing the restriction may be performed, as described in the first embodiment.

Further, although the camera 13 is used to estimate the state of the user in FIG. 22, sensors other than the camera 13 may be used. Specifically, if the present location of the user acquired by, for example, GPS is, for example, a park, it can be estimated that the user may be walking or running. On the other hand, the present location of the user acquired by GPS is, for example, on a railway track, it can be estimated that the user may be on a train. Moreover, the state of the user (for example, in a car or on a train) can also be estimated by analyzing ambient sound detected by a microphone. Although the GPS antenna and the microphone are described as examples of other sensors, sensors other than them may be used. If the camera 13 and other sensors are used in combination, estimation accuracy of the state of the user can be improved.

Further, the camera 13 may be started only when the state of the user cannot be estimated only based on information detected by sensors other than the camera 13 to reduce the energy consumption. Moreover, the camera 13 may be started when change of the state of the user is detected. The change of the state of the user can be detected when it is determined that the user moves by a distance greater than or equal to a preset value (threshold value) based on, for example, position information acquired by GPS. Further, the change of the state of the user can be detected based on ambient sound detected by the microphone. Such a structure allows the energy consumption of the electronic apparatus 20 to be reduced.

It should be noted that the user can turn off (remove) the automatic display control function by operating the electronic apparatus 20 in the electronic apparatus 20 according to this embodiment as well as in the first embodiment. Since the processing procedures of the electronic apparatus 20 to turn off the automatic display control function are described in the first embodiment, detailed description thereof will be omitted.

As described above, the display on the display 12 is controlled in accordance with the imaging result around the user by the camera 13 (imaging device) in this embodiment. Since the display area or display content of the display 12 can be changed (restricted) in accordance with the state of the user (action), for example, the state where the user is on a vehicle, the state where the user is walking or the state where the user is running, the safety of the user wearing the electronic apparatus 20, people around the user, etc., can be ensured.

### Third Embodiment

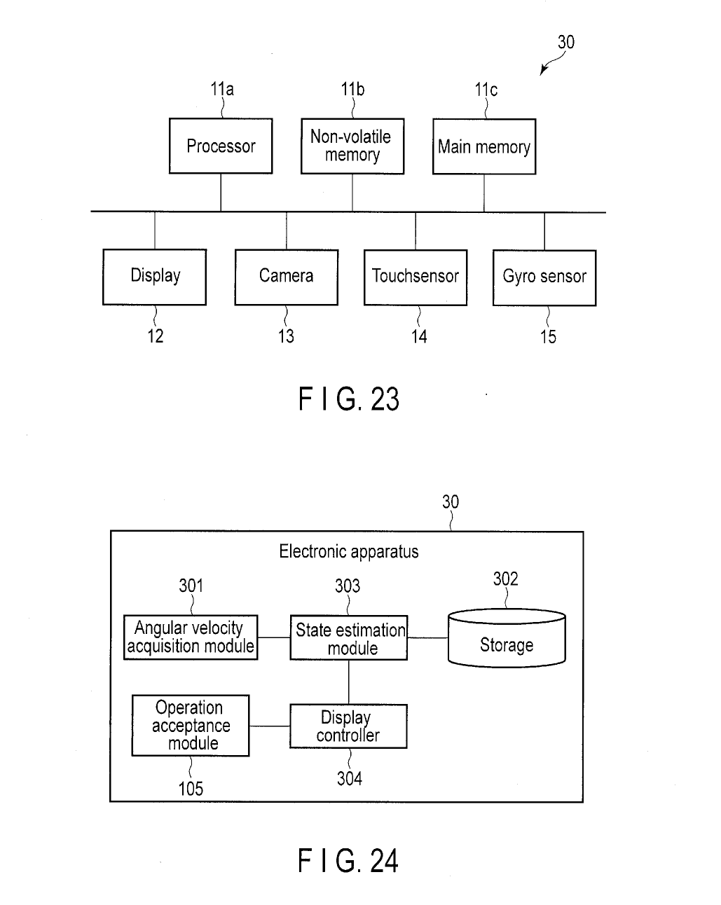

Next, a third embodiment will be described. FIG. 23 shows a system configuration of an electronic apparatus according to this embodiment. In FIG. 23, portions similar to those in FIG. 2 are denoted by the same reference numbers, and detailed description thereof will be omitted. Here, portions different from those in FIG. 2 will be mainly described. Further, since an outer appearance of the electronic apparatus according to this embodiment is the same as that in the first embodiment, it will be properly described using FIG. 1.

This embodiment is different from the first and second embodiments in that the state of the user (action) is estimated based on information concerning acceleration that acts on the electronic apparatus.

As shown in FIG. 23, an electronic apparatus 30 according to this embodiment includes a gyro sensor 15. The gyro sensor 15 is a detector (sensor) configured to detect angular velocity (information) which is change of a rotating angle per unit time as the information concerning the acceleration that acts on the electronic apparatus 30. The gyro sensor 15 is embedded in, for example, the electronic apparatus body 11. It should be noted that, for example, an acceleration sensor may be used as a detector configured to detect the information concerning the acceleration that acts on the electronic apparatus 30. Further, a detection result of both the gyro sensor 15 and the acceleration sensor may be used.

FIG. 24 is a block diagram mainly showing a functional configuration of the electronic apparatus 30 according to this embodiment. In FIG. 24, portions similar to those in FIG. 3 are denoted by the same reference numbers, and detailed description thereof will be omitted. Here, portions different from those in FIG. 3 will be mainly described.

As shown in FIG. 24, the electronic apparatus 30 includes an angular velocity acquisition module 301, a storage 302, a state estimation module 303 and a display controller 304.

In this embodiment, all or part of the angular velocity acquisition module 301, the state estimation module 303 and the display controller 304 may be realized by software, may be realized by hardware, or may be realized as a combination of the software and hardware. Further, in this embodiment, the storage 302 is stored in the non-volatile memory 11b.

Although the electronic apparatus 30 includes the storage 302 in FIG. 24, the storage 302 may be provided in an external device communicably connected to the electronic apparatus 30.

The angular velocity acquisition module 301 acquires angular velocity information detected by the gyro sensor 15. The angular velocity information acquired by the angular velocity acquisition module 301 allows vibration (pattern) caused to the electronic apparatus 30 to be acquired (detected).

The storage 302 prestores the state estimation information in which, for example, the state of the user estimated from the vibration (pattern) caused to the electronic apparatus 30 is defined.

The state estimation module 303 estimates the state of the user wearing the electronic apparatus 30 based on the angular velocity information acquired by the angular velocity acquisition module 301 and the state estimation information stored in the storage 302.

The display controller 304 includes a function (automatic display control function) of controlling the display (state) on the display 12 based on the state of the user estimated by the state estimation module 303 (that is, information detected by the gyro sensor 15).

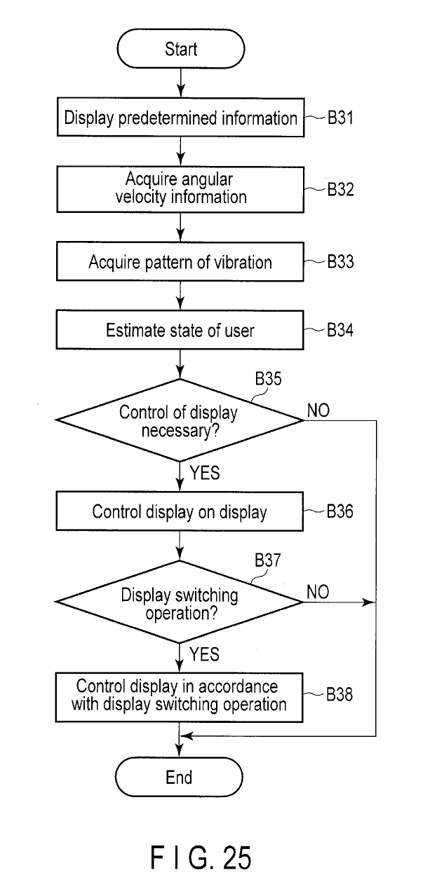

Next, processing procedures of the electronic apparatus 30 according to this embodiment will be described with reference to the flowchart of FIG. 25.

First, processing of block B31 equivalent to the processing of block B1 shown in FIG. 4 is executed.

Next, the angular velocity acquisition module 301 acquires angular velocity information detected by the gyro sensor 15 (block B32).

The state estimation module 303 acquires a pattern of a vibration (hereinafter referred to as a vibration pattern) caused to the electronic apparatus 30 by an external factor by analyzing an amount of exercise based on the angular velocity information acquired by the angular velocity acquisition module 301 (block B33).

The state estimation module 303 estimates the state of the user based on the acquired vibration pattern and the state estimation information stored in the storage 302 (block B34).

Here, the state of the user estimated from, for example, each of a plurality of prepared vibration patterns is defined in the state estimation information stored in the storage 302. It should be noted that the state of the user which can be estimated by the state estimation information includes, for example, the state where the user is on a moving vehicle, the state where the user is walking and the state where the user is running.

The use of such state estimation information allows the state estimation module 303 to specify the state of the user estimated from (a vibration pattern equal to) the acquired vibration pattern.

In the processing of block B34, the state where the user is on a vehicle is estimated if a vibration pattern equivalent to, for example, that caused on a vehicle is acquired. Further, the state where the user is walking is estimated if a vibration pattern equivalent to, for example, that caused during walking is acquired. Moreover, the state where the user is running is estimated if a vibration pattern equivalent to, for example, that caused during running is acquired.

Moreover, different vibrations (shakes) can be detected using the gyro sensor 15 in accordance with, for example, a type of vehicle containing the user. Thus, for example, a state where the user is in a car, a state where the user is on a train, a state where the user is on a bus, a state where the user is on a motorcycle and a state where the user is on a bicycle can be estimated as the state where the user is on a vehicle using the gyro sensor 15. In this case, it suffices that the storage 302 prestores a vibration pattern caused on each of the vehicles (the state estimation information in which the state of the user estimated from the vibration pattern is defined).

It should be noted that the state estimation module 303 can calculate angular information by carrying out an integration operation of the angular velocity (information) detected by, for example, the gyro sensor 15 and acquire (detect) a moving angle (direction). The state of the user can be estimated with high accuracy using the moving angle calculated in this manner.

Further, the state of the user estimated by the state estimation module 303 may be states other than those described above. Specifically, if the moving angle is acquired as described above, a vibration pattern caused by movement in a vertical direction can be acquired. Thus, for example, a state where the user is on a vehicle such as an elevator or an escalator, or a state where the user is doing bending and stretching exercises can also be estimated in accordance with the vibration pattern.

It should be noted that the user can be caused to register the type of vehicle (for example, car or train).

The state estimation information stored in the storage 302 can be properly updated.

Next, the display controller 304 determines whether the display on the display 12 needs to be controlled (changed) or not based on the state of the user estimated by the state estimation module 303 (block B35).

Here, if, for example, the user is in a car, on a motorcycle or on a bicycle in a state where information is displayed on the display 12, the user's sight to the surroundings is not sufficiently secured, or the user cannot concentrate on driving. Then, an accident, etc., may be caused. Further, the state where information is displayed on the display 12 may cause a collision, etc., with a person or an object around the user as well as when the user is walking or running. Accordingly, if the state where the user is in a car, the state where the user is on a motorcycle, the state where the user is on a bicycle, the state where the user is walking and the state where the user is running are estimated by the state estimation module 303, the display controller 304 determines that the display on the display 12 needs to be controlled (restricted). On the other hand, if, for example, the user is on a train or a bus, an accident or a collision is not likely to be caused. Thus, if the state where the user is on a train or a bus is estimated by the state estimation unit 303, the display controller 304 determines that the display on the display 12 need not be controlled.

Even if, for example, the state where the user is in a car is estimated, the display on the display 12 need not be controlled (restricted) if the user is not a driver but a fellow passenger. Then, it may be determined that the display on the display 12 needs to be controlled only when, for example, an image taken by the camera 13 is analyzed, and it is determined that a steering wheel is at close range to the user (for example, approximately 10 to 50 cm) (that is, when the user wearing the electronic apparatus 30 is a driver). Moreover, it may be determined that the display on the display 12 need not be controlled if it is determined that a vehicle is stopping, based on the angular velocity information (vibration information) detected by the gyro sensor 15, the amount of movement calculated from the image (here, moving image) taken by the camera 13 described in the second embodiment, or the like.

On the other hand, if, for example, the user is on a motorcycle or a bicycle, the user is highly likely to drive it. Thus, if the state where the user is on a motorcycle or a bicycle is estimated, it is determined that the display on the display 12 needs to be controlled.

Further, even if, for example, the user is walking or running, it may be determined that the display on the display 12 need not be controlled if the user is walking or running using an instrument such as a treadmill in a gym, etc. Whether the gym is utilized or not may be determined by analyzing an image taken by the camera 13, or by causing the user to register that the gym is utilized. Further, it may be determined based on a present location, etc., acquired by GPS.

If it is determined that the display on the display 12 needs to be controlled (YES in block B35), the display controller 304 controls the display on the display 12 by the automatic display control function (block B36). Since the processing of controlling the display on the display 12 by the display controller 304 is similar to those in the first and second embodiments, detailed description thereof will be omitted. That is, the display controller 304 performs control to, for example, change a display area (pattern) or display content of information on the display 12.

Here, the display area of the display 12 may be changed to, for example, any of the first to fifth display patterns to secure the user's sight to the surroundings; however, it may be changed to a different display area pattern in accordance with the state of the user estimated by the state estimation module 303. Specifically, if the state of the user estimated by the state estimation module 303 is a state where the user is in a car, on a motorcycle or on a bicycle, the display area of the display 12 may be changed to, for example, the first display area pattern in which information is displayed only in an area lower than the center of the display 12, or the fifth display area pattern (that is, display of information is turned off), as described in the second embodiment. On the other hand, if the state of the user estimated by the state estimation unit 303 is a state where the user is walking or running, the display area of the display 12 may be changed to, for example, the first display area pattern in which information is displayed only in an area located above the center of the display 12, or the third display area pattern in which information is displayed in triangle areas located in the upper part of the display 12, as described in the second embodiment.

When the processing of block B36 is executed as described above, processing of blocks B37 and B38 equivalent to the processing of blocks B7 and B8 shown in FIG. 4 is executed. Since the display switching operation in blocks B37 and B38 is similar to that in the first embodiment, detailed description thereof will be omitted.

If it is determined that the display on the display 12 need not be controlled in block B35 (NO in block B35), the processing after block B36 is not executed, and the display state of the display 12 by the processing of block B31 is maintained.

Similarly, if it is determined that the display switching operation is not accepted in block B37 (NO in block B37), the processing of block B38 is not executed, and the display state of the display 12 by the processing of block B36 is maintained.

The processing shown in FIG. 25 allows the display on the display 12 to be controlled in accordance with (the state of the user estimated based on) the imaging result by the camera 13 and the angular velocity information detected by the gyro sensor 15.

After control of restricting the display on the display 12 is performed, control of removing the restriction may be performed, as described in the first embodiment.

Further, although the camera 13 and the gyro sensor 15 are used to estimate the state of the user in this embodiment, other sensors such as a GPS antenna and a microphone may be used, as described in the second embodiment. If the camera 13 and gyro sensor 15 and another sensor are used in combination, estimation accuracy of the state of the user can be improved. On the other hand, the state of the user may be estimated using only the gyro sensor 15 without the camera 13.

The user can turn off (remove) the automatic display control function by operating the electronic apparatus 30 in the electronic apparatus 30 according to this embodiment as well as in the first and second embodiments. Since the processing procedures of the electronic apparatus 30 to turn off the automatic display control function are described in the first embodiment, detailed description thereof will be omitted.

As described above, the state of the user is estimated based on the angular velocity information detected by the gyro sensor 15 (detector) (information concerning acceleration), and the display on the display 12 is controlled in accordance with the estimated state in this embodiment. Since the display area or display content of the display 12 can be changed (restricted) in accordance with the state of the user (action), for example, the state where the user is on a vehicle (a car, a motorcycle, a bicycle or the like), the state where the user is walking or the state where the user is running, the safety of the user wearing the electronic apparatus 30, people around the user, etc., can be ensured.

Moreover, since whether, for example, the user is a driver or a fellow passenger can also be estimated by estimating the state of the user in accordance with the angular velocity information detected by the gyro sensor 15 and the imaging result by the camera 13 in this embodiment, the display on the display 12 can be controlled only when necessary (for example, when the user is a driver).

### Fourth Embodiment

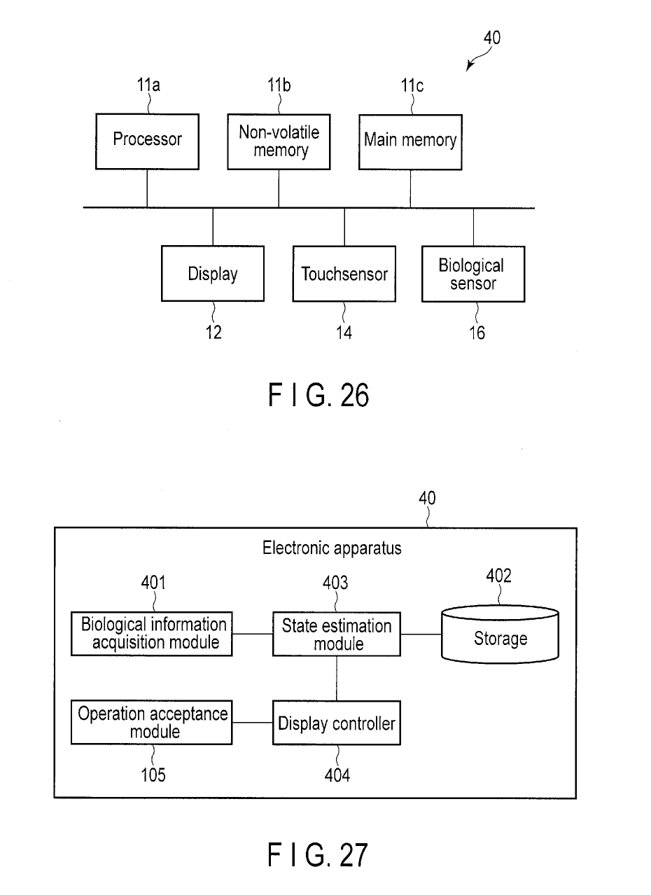

Next, a fourth embodiment will be described. FIG. 26 shows a system configuration of an electronic apparatus according to this embodiment. In FIG. 26, portions similar to those in FIG. 2 are denoted by the same reference numbers, and detailed description thereof will be omitted. Here, portions different from those in FIG. 2 will be mainly described. Further, since an outer appearance of the electronic apparatus according to this embodiment is the same as that in the first embodiment, it will be properly described using FIG. 1.

This embodiment is different from the first to third embodiments in that the state of the user (physical condition) is estimated based on information concerning a biological body of the user wearing the electronic apparatus.

As shown in FIG. 26, an electronic apparatus 40 includes a biological sensor 16. The biological sensor 16 includes a plurality of types of sensor such as an acceleration sensor configured to measure body motion (acceleration), a thermometer configured to measure a skin temperature (body temperature) and an electrocardiographic sensor configured to measure a cardiac potential (heartbeat interval), and is a detector configured to detect biological information per unit time by driving these sensors. The biological sensor 16 is embedded in, for example, the electronic apparatus body 11.

FIG. 27 is a block diagram mainly showing a functional configuration of the electronic apparatus 40 according to this embodiment. As shown in FIG. 27, the electronic apparatus 40 includes a biological information acquisition module 401, a storage 402, a state estimation module 403 and a display controller 404.

In this embodiment, all or part of the biological information acquisition module 401, the state estimation module 403 and the display controller 404 may be realized by software, may be realized by hardware, or may be realized as a combination of the software and hardware. Further, in this embodiment, the storage 402 is stored in the non-volatile memory 11b.

Although the electronic apparatus 40 includes the storage 402 in FIG. 27, the storage 402 may be provided in an external device communicably connected to the electronic apparatus 40.

The biological information acquisition module 401 acquires biological information detected by the biological sensor 16.

The storage 402 prestores the state estimation information in which, for example, the state of the user estimated from (a pattern of) the biological information is defined.

The state estimation module 403 estimates the state of the user wearing the electronic apparatus 40 based on the biological information acquired by the physiological information acquisition module 401 and the state estimation information stored in the storage 402.

The display controller 404 includes a function (automatic display control function) of controlling the display (state) on the display 12 based on the state of the user estimated by the state estimation module 403 (that is, information detected by the biological sensor 16).

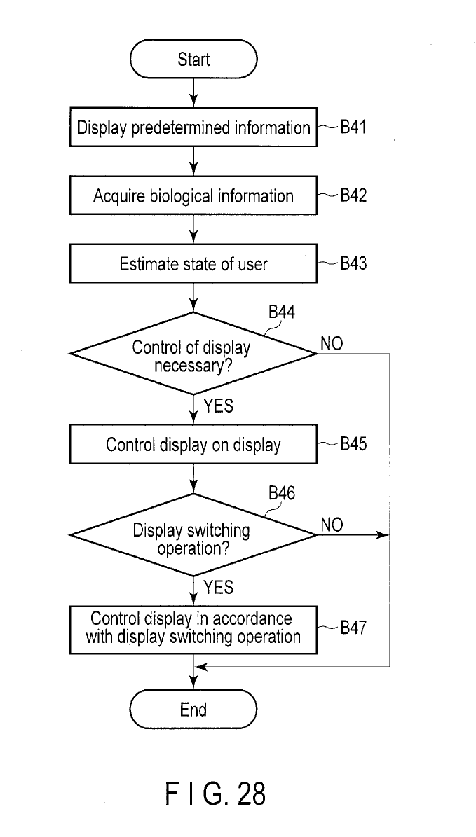

Next, processing procedures of the electronic apparatus 40 according to this embodiment will be described with reference to the flowchart of FIG. 28.

First, processing of block B41 equivalent to the processing of block B1 shown in FIG. 4 is executed.

Next, the physiological information acquisition module 401 acquires the biological information detected by the biological sensor 16 (block B42). It should be noted that the biological information acquired by the biological information acquisition module 401 (that is, the biological information detected by the biological sensor 16) includes (information of) the body motion measured by the acceleration sensor, the skin temperature measured by the thermometer, the cardiac potential measured by the electrocardiographic sensor, etc., which are mounted on the biological sensor 16. Further, the acceleration sensor can measure, for example, the acceleration due to gravity. Thus, the body motion included in the biological information includes, for example, a body position of the user (that is, direction of body) specified in accordance with the direction of the acceleration of gravity measured by the acceleration sensor.

The state estimation module 403 analyzes a health condition of the user from the biological information acquired by the biological information acquisition module 401, and estimates the state of the user based on the analysis result and the state estimation information stored in the storage 402 (block B43).

Here, the state of the user estimated from, for example, each of (patterns of) a plurality of prepared biological information items is defined in the state estimation information stored in the storage 402. It should be noted that the state of the user which can be estimated by the state estimation information includes a state where a convulsion is caused, a state where a fever is caused, a state where arrhythmia is caused, a state where the user is sleeping, etc.

The use of such state estimation information allows the state estimation module 403 to specify the state of the user estimated from a pattern of (biological information equal to) the acquired biological information.

In the processing of block B43, the state where a convulsion is caused is estimated if the biological information equivalent to the pattern of the biological information when, for example, the convulsion is caused (for example, body motion different from that in normal times) is acquired. Further, the state where a fever is caused is estimated if the biological information equivalent to the pattern of the physiological information when, for example, the fever is caused (for example, skin temperature higher than a preset value) is acquired. Moreover, the state where arrhythmia is caused is estimated if the biological information equivalent to the pattern of the biological information when, for example, the arrhythmia is caused (for example, cardiac potential different from that in normal times) is acquired. Further, the state where the user is sleeping is estimated if the biological information equivalent to the pattern of the biological information when, for example, the user is sleeping (for example, body motion and direction of body during sleeping) is acquired.

It should be noted that the state of the user estimated by the state estimation module 303 may be states other than those described above. Specifically, a state where the health condition of the user is abnormal (that is, indisposed), etc., can be estimated by comprehensively considering (body motion, skin temperature, cardiac potential, etc., of) the biological information detected by the biological sensor 16. On the other hand, a state where the health condition of the user is normal can be estimated by comprehensively considering the biological information detected by the physiological sensor 16.

The state estimation information stored in the storage 402 can be properly updated.

Next, the display controller 404 determines whether the display on the display 12 needs to be controlled (changed) or not based on the state of the user estimated by the state estimation module 403 (block B44).

Here, if, for example, the user suffers from the convulsion, fever, arrhythmia, etc., (that is, the user is indisposed) in a state where the predetermined information is displayed on the display 12, the user cannot fully take a rest due to, for example, viewing stress, which may cause deterioration of the health condition of the user. Further, if the user is sleeping, information need not be displayed on the display 12. Thus, if the state where the convulsion, fever or arrhythmia is caused, or the state where the user is sleeping is estimated by the state estimation module 403, the display controller 404 determines that the display on the display 12 needs to be controlled. On the other hand, if other states (for example, a state where the health condition of the user is normal) are estimated by the state estimation module 403, the display controller 404 determines that the display on the display 12 need not be controlled.

If it is determined that the display on the display 12 needs to be controlled (YES in block B44), the display controller 404 controls the display on the display 12 by the automatic display control function (block B45).

In this embodiment, the display controller 404 performs control of changing the display area pattern of the information on the display 12 to the fifth display area pattern (that is, display of information is turned off) to, for example, reduce the viewing stress. Control of changing it to another display area pattern may be performed.

Although the control of turning off the display of the information on the display 12 is described, control of changing the display content of the display 12 may be performed in accordance with the state of the user estimated by the state estimation module 403. Specifically, if the state where the convulsion, fever or arrhythmia is caused is estimated by the state estimation module 403, control of stopping the reproduction of a motion picture (for example, picture containing strenuous movement) may be performed.

When the processing of block B45 is executed as described above, processing of blocks B46 and B47 equivalent to the processing of the blocks B7 and B8 shown in FIG. 4 is executed. Since the display switching operation in blocks B46 and B47 is similar to that in the first embodiment, detailed description thereof will be omitted.

If it is determined that the display on the display 12 need not be controlled in block B44 (NO in block B44), the processing after block B45 is not executed, and the display state of the display 12 by the processing of block B41 is maintained.

Similarly, if it is determined that the display switching operation is not accepted in block B46 (NO in block B46), the processing of block B47 is not executed, and the display state of the display 12 by the processing of block B45 is maintained.

The processing shown in FIG. 28 allows the display on the display 12 to be controlled in accordance with (the state of the user estimated based on) the biological information detected by the biological sensor 16.

After control of restricting the display on the display 12 is performed, control of removing the restriction may be performed, as described in the first embodiment.

Further, although the biological sensor 16 is used to estimate the state of the user in FIG. 28, sensors other than the biological sensor 16 may be used. Specifically, the state of the user (health condition) can be estimated from movement of the user's eyeballs and the state of pupils using, for example, a camera by which eye movement of the user can be imaged. Further, the state where the user is sleeping can be estimated if sound of breath, etc., made by, for example, a snore symptom of the user during sleeping is detected using, for example, a microphone. Although the camera and the microphone are described as examples of other sensors, sensors other than them may be used. If the biological sensor 16 and other sensors are used in combination, estimation accuracy of the state of the user can be improved.

It should be noted that the user can turn off (remove) the automatic display control function by operating the electronic apparatus 40 in the electronic apparatus 40 according to this embodiment as well as in the first to third embodiments. Since the processing procedures of the electronic apparatus 40 to turn off the automatic display control function are described in the first embodiment, detailed description thereof will be omitted.

As described above, the display on the display 12 is controlled in accordance with the biological information detected by the biological sensor 16 (detector) (information concerning the biological body of the user) in this embodiment. Since the display area or display content of the display 12 can be changed (restricted) in accordance with the state of the user (health condition), for example, the state where the convulsion, fever or arrhythmia is caused (that is, indisposed), or the state where the user is sleeping, the display control of the display 12 can be performed in consideration of the health condition of the user wearing the electronic apparatus 40. That is, this embodiment allows the viewing stress during a bad physical condition to be reduced.

It should be noted that the electronic apparatus 40 according to this embodiment can also be realized in combination with the first to third embodiments. That is, the electronic apparatus 40 may include both the automatic display control function of the first to third embodiments in which the camera 13, the gyro sensor 15, etc., are used and the automatic display control function of this embodiment in which the biological sensor 16 is used. This allows the display control of the display 12 suitable for the state or condition of the user to be performed.

At least one of the above embodiments allows the display control of the display 12 matching the state of the user wearing the electronic apparatus to be performed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus in which user can see through at least a transparent part of a first display area when the electronic apparatus is worn on a body of the user, the apparatus comprising:
a camera configured to take an image of surroundings comprising a region which the user cannot see through at least a transparent part of the first display area when the electronic apparatus is worn on a body of the user; and
circuitry configured to perform controlling display of the first display area by using the image of surroundings.

2. The electronic apparatus of claim 1, further comprising a detector configured to detect information concerning acceleration,
wherein the circuitry is further configured to perform controlling display of the first display area by using a state of the user based on the image of surroundings and the detected information.

3. The electronic apparatus of claim 1, further comprising a detector configured to detect information concerning a biological body of the user,
wherein the circuitry is further configured to perform controlling display of the first display area by using the detected information.

4. The electronic apparatus of claim 1, further comprising a detector configured to detect a moving direction of a contact position by a finger of the user,
wherein the circuitry is further configured to accept a first operation when the detected moving direction is a first direction, and to accept a second operation when the moving direction is a second direction.

5. The electronic apparatus of claim 1, wherein
the circuitry is further configured to perform controlling display of the first display area based on an operation by the user when the operation is accepted after the controlling is performed by using the image of surroundings.

6. A method executed by an electronic apparatus in which user can see through at least a transparent part of a first display area when the electronic apparatus is worn on a body of the user, the method comprising:
displaying an image of surroundings comprising a region which the user cannot see through at least a transparent part of the first display area when the electronic apparatus is worn on a body of the user; and
controlling display of the first display area by using the image of surroundings.

7. The method of claim 6, further comprising detecting information concerning acceleration,
wherein the controlling comprises controlling display of the first display area by using a state of the user based on the image of surroundings and the detected information.

8. The method of claim 6, further comprising detecting information concerning a biological body of the user,
wherein the controlling comprises controlling display of the first display area by using the detected information.

9. The method of claim 6, further comprising detecting a moving direction of a contact position by a finger of the user,
wherein a first operation is accepted when the detected moving direction is a first direction, and a second operation is accepted when the moving direction is a second direction.

10. The method of claim 6, wherein the controlling comprises controlling display of the first display area in accordance with an operation by the user when the operation is accepted after the controlling is performed by using the image of surroundings.

11. A non-transitory computer-readable storage medium having stored thereon a computer program which is executable by a computer of an electronic apparatus in which user can see through at least a transparent part of a first display area when the electronic apparatus is worn on a body of the user, the computer program comprising instructions capable of causing the computer to execute functions of:
displaying an image of surroundings comprising a region which the user cannot see through at least a transparent part of the first display area when the electronic apparatus is worn on a body of the user; and
controlling display of the first display area by using the image of surroundings.

12. The storage medium of claim 11, wherein
the computer program further comprises instructions capable of causing the computer to further execute a functions of detecting information concerning acceleration, and
the controlling comprises controlling display of the first display area by using a state of the user based on the image of surroundings and the detected information.

13. The storage medium of claim 11, wherein
the computer program further comprises instructions capable of causing the computer to further execute a function of detecting information concerning a biological body of the user, and
the controlling comprises controlling display of the first display area by using the detected information.

14. The storage medium of claim 11, wherein
the computer program further comprises instructions capable of causing the computer to further execute a function of detecting a moving direction of a contact position by a finger of the user, and
wherein the controlling comprising accepting a first operation when the detected moving direction is a first direction, and accepting a second operation when the moving direction is a second direction.

15. The storage medium of claim 11, wherein the controlling comprises controlling display of the first display area in accordance with an operation by the user when the operation is accepted after the controlling is performed by using the image of surroundings.
